(19) United States
(12) Patent Application Publication
(10) Pub. No.: US 2010/0269164 A1
(43) Pub. Date: Oct. 21, 2010

(54) ONLINE SERVICE DATA MANAGEMENT

(75) Inventors: Lara M. Sosnosky, Kirkland, WA (US); Elissa E. S. Murphy, Seattle, WA (US); Navjot Virk, Bellevue, WA (US); Yan V. Leshinsky, Bellevue, WA (US); Abolade Gbadegesin, Seattle, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/423,830

(22) Filed: Apr. 15, 2009

(51) Int. Cl. G06F 17/30; H04L 9/32

(52) U.S. Cl. 726/7; 707/E17.005; 707/E17.007

(57) ABSTRACT

The claimed subject matter relates to an architecture that can facilitate automatic backup and versioning of online content. Appreciably, the architecture can relate to a network-accessible, online data archival service with a central backup data store for archiving online content published to disparate online services for clients of the archival service who are also clients of the disparate online service(s). The architecture can maintain rich content versioning, and can further provide additional services with respect to archived data such as restoration (to the original site, a disparate site, or a user device); synchronization between various online sites or between one or more sites and the backup data store; and conversion. The conversion can be employed in connection with backup, restore, or synch procedures and can apply to either a file format of the content or to a scope of the source of the content versus the scope of the destination.

### CROSS-REFERENCE TO RELATED APPLICATIONS

This application is related to co-pending U.S. patent application Ser. No. (MSFTP2573US) ______ filed on ______ and entitled, “EMPLOYING USER-CONTEXT IN CONNECTION WITH BACKUP OR RESTORE OF DATA.” The entirety of this application is incorporated herein by reference.

### BACKGROUND

Since the launch of the computer revolution decades ago, data has been steadily migrated or been duplicated to exist in electronic or digital form. Moreover, new data associated with individuals is often directly created in electronic format due to the widespread availability of computers and the convenience and ease associated therewith. Today, a very significant portion of personal or other information about many individuals or other entities exists in electronic form. Most of these individuals are very concerned with protecting that data. Accordingly, numerous data storage services have entered the marketplace. These data storage services typically host or maintain the data associated with the user in exchange for a service fee.

Regardless, backing up or archiving data is generally thought of in terms of remotely storing copies of files that exist on a local machine. Yet the reality of today's environment is that much of the information individuals care about and interact with on a daily basis exists on the web, often hosted or maintained by online social networking services. Conventional archival systems or services are inadequate for dealing with this online content.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

The subject matter disclosed and claimed herein, in one or more aspects thereof, comprises an architecture that can facilitate automatic backup and versioning of online content. In accordance therewith and to other related ends, the architecture can access a store associated with an online service on behalf of a user of the online service. By way of such a connection established with the store, the architecture can import from the store online content associated with the user and maintained by the online service. Thus, the architecture can archive the online content to a central backup data store as a recent version of the online content. The backup data store can be associated with a cloud-based backup service that facilitates or manages the features or aspects described herein.

In addition, the architecture can be configured to restore or synchronize archived content included in the backup data store to at least one of the stores associated with the online service or to a disparate store associated with a disparate online service. These operations, along with backup operations detailed supra, can leverage or perform conversion of the content. In particular, a file format associated with the content can be converted to a second file format suitable for the destination of the content. Additionally or alternatively, a scope associated with a source online service can be converted to a scope associated with a destination online service or to a scope associated with the backup data store.

The following description and the annexed drawings set forth in detail certain illustrative aspects of the claimed subject matter. These aspects are indicative, however, of but a few of the various ways in which the principles of the claimed subject matter may be employed and the claimed subject matter is intended to include all such aspects and their equivalents. Other advantages and distinguishing features of the claimed subject matter will become apparent from the following detailed description of the claimed subject matter when considered in conjunction with the drawings.

### BRIEF DESCRIPTION OF THE DRAWINGS

FIG. 1 illustrates a block diagram of a computer-implemented system that can facilitate automatic versioned backup of online content.

FIG. 2 depicts a block diagram of system that can provide an aggregated view of online content from multiple sources.

FIG. 3 provides block diagram of a system that can, inter alia, restore content to online services.

FIG. 4 depicts a block diagram of s system that can facilitate synchronization of online or archived content by way of a cloud synchronization service.

FIG. 5 provides block diagram that illustrates relationships between the various elements associated with a backup, restore, and/or synchronization storage model.

FIG. 6 is a block diagram of a system that can provide for or aid with various inferences or intelligent determinations.

FIG. 7 depicts an exemplary flow chart of procedures that define a method for facilitating automatic backup and versioning of online content.

FIG. 8 illustrates an exemplary flow chart of procedures that define a method for providing additional features in connection with facilitating automatic backup and versioning of online content.

FIG. 9 depicts an exemplary flow chart of procedures defining a method for restoring or presenting views of archived content as well as converting or synchronizing either online or archived content.

FIG. 10 illustrates a block diagram of a computer operable to execute or implements all or portions of the disclosed architecture.

FIG. 11 illustrates a schematic block diagram of an exemplary computing environment.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the terms “component,” “module,” “system,” or the like can, but need not, refer to a computer-related entity, either hardware, a combination of hardware and software, software, or software in execution. For example, a component might be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or.” Therefore, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As used herein, the terms “infer” or “inference” generally refer to the process of reasoning about or inferring states of the system, environment, and/or user from a set of observations as captured via events and/or data. Inference can be employed to identify a specific context or action, or can generate a probability distribution over states, for example. The inference can be probabilistic that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

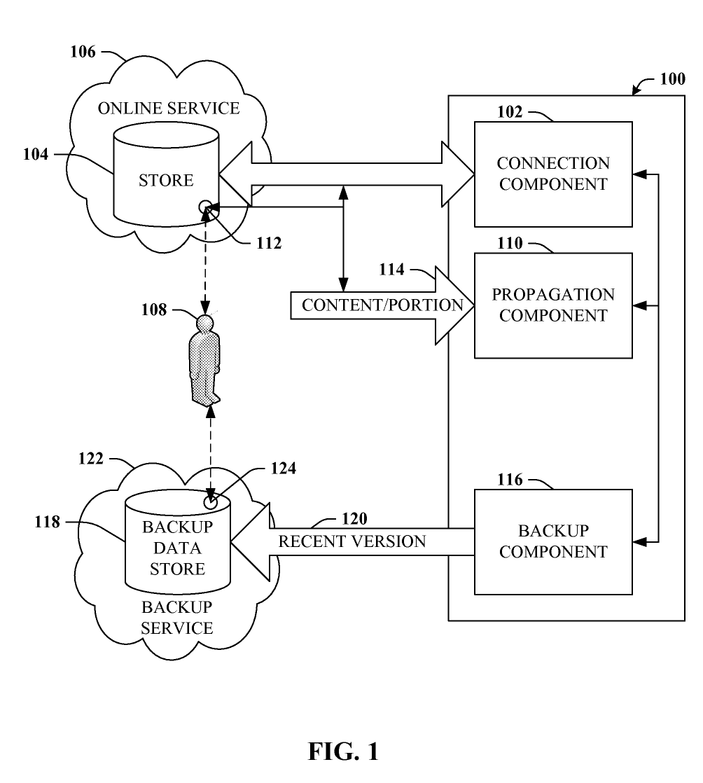

Referring now to the drawings, with reference initially to FIG. 1, computer-implemented system 100 that can facilitate automatic versioned backup of online content is depicted. Generally, system 100 can include connection component 102 that can access store 104 associated with online service 106. In particular, connection component 102 can interface or access store 104 on behalf user 108 of online service 106. Appreciably, online service 106 can be substantially any service, but in general can specifically relate to a social networking service, many examples of which are well known. Typically, such services provide for or encourage users (e.g., user 108) to store images or video or other data, manage friends or other contacts, engage in communication with those friends or contacts, and so forth.

In accordance therewith, the associated store 104 can be maintained by online service 106 and can be (as with other stores described herein) physically hosted on a centralized server (or other device) or server array, or on a set of servers that are geographically distributed. Furthermore, all or portions of store 104 (or other stores detailed herein) can be embodied as substantially any type of memory, including but not limited to volatile or non-volatile, solid state, sequential access, structured access, or random access and so on, and further can be comprised of substantially any suitable type of storage media.

Regardless, connection component 102 can access, interface, and/or establish a connection session with store 104, typically by way of at least one access-oriented application programming interface (API), which is further detailed infra. In one or more aspects of the claimed subject matter, connection component 102 can employ credentials of user 108 when interfacing with online service 106 and/or accessing data store 104. Appreciably, utilization of credentials associated with user 108 can be based upon express authorization from user 108.

Accordingly, system 100 can include propagation component 110 that can import, from store 104, online content 112 associated with user 108 and maintained by online service 106. Online content 112 can be substantially any content associated with user 108, but can commonly relate to data published by user 108 to online service 106. In the cases where online service 106 is a social networking service, it can be expected that online content 112 published to the online service 106 can be social networking-oriented data such as, e.g., weblogs (e.g., blogs), notes, documents, descriptions, photos, videos and the like. However, it should be understood that online content 112 can also relate to contact lists, favorites lists, or other objects as well as to metadata associated with the online content, lists, or objects, or to a layout or schema associated with the online content. Propagation component 110 can import all online content 112 associated with user 108, or in many cases import merely a portion of online content 112, both of which are intended to be illustrated by reference numeral 114.

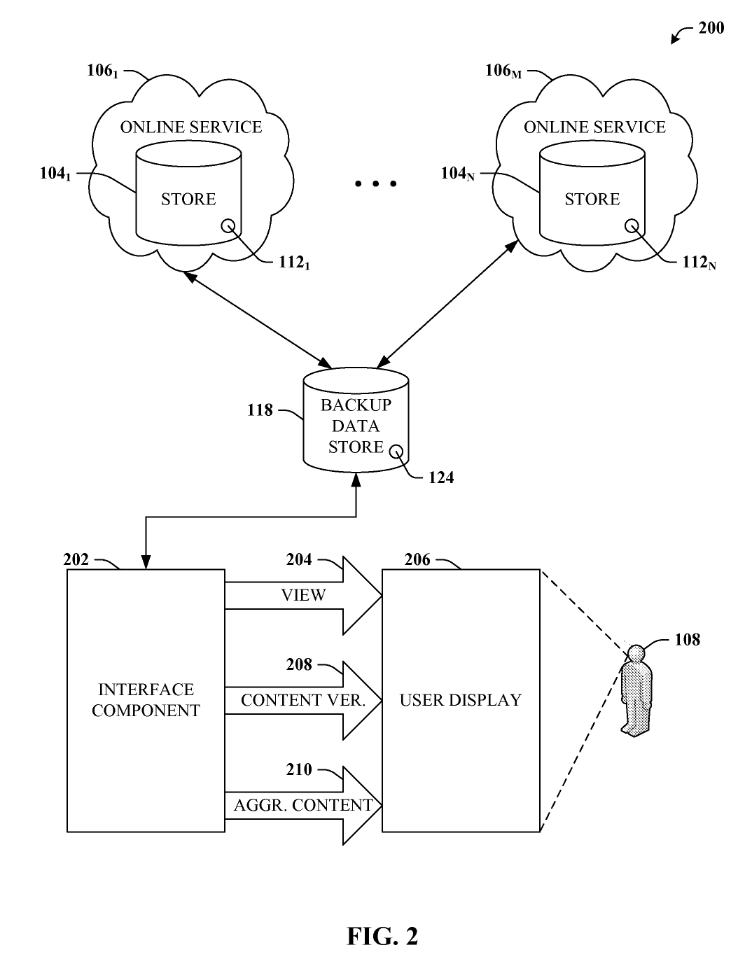

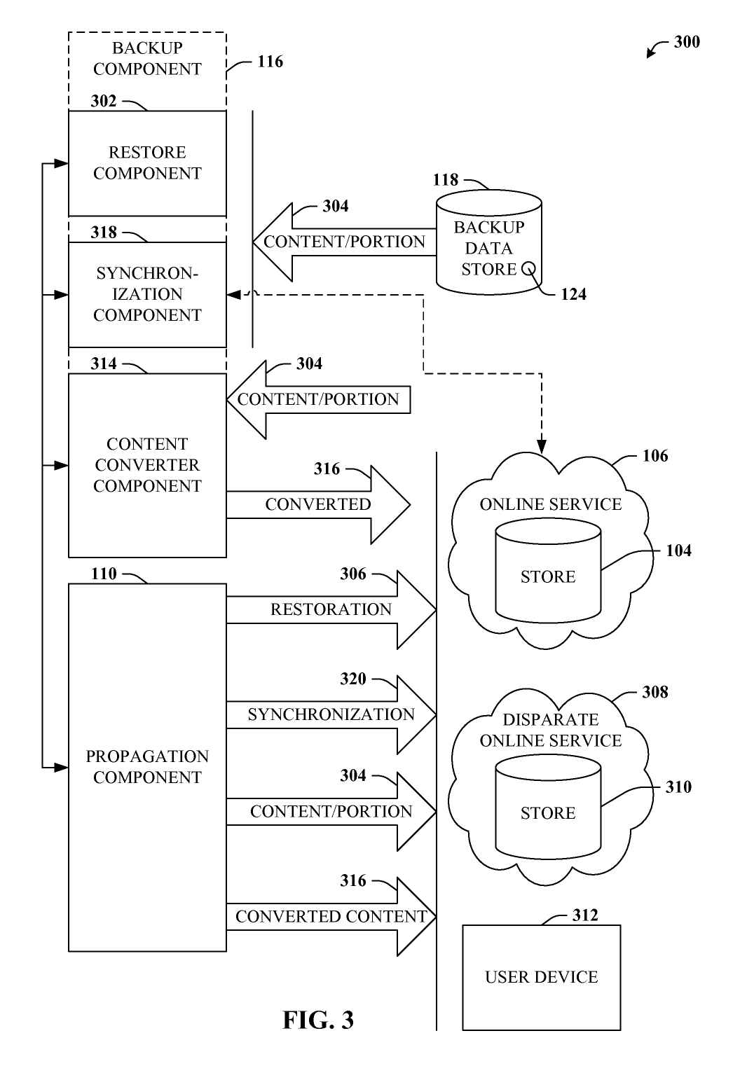

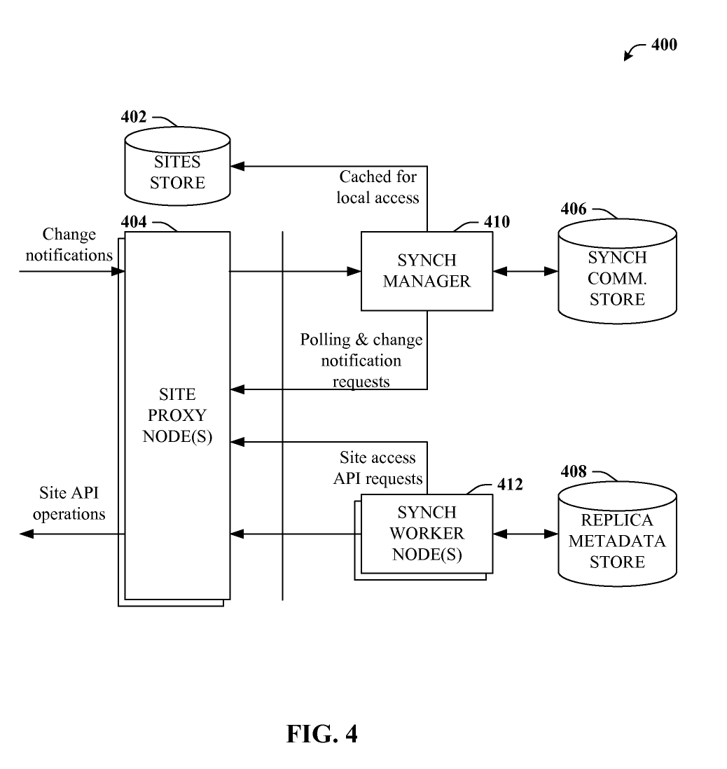

In addition, system 100 can also include backup component 116 that can archive all or any portion 114 of online content 112 that propagation component 110 obtains. Backup component 116 can archive portion 114 to backup data store 118 as recent version 120 of online content 112. Thus, backup data store 118 can include archived content 124 that can include not only a backup of all of online content 112, but archived content 124 can further include various different versions of online content 112. For example, consider the case in which online content 112 is a blog about politics that user 108 updates about once or twice a week. In that case, archived data 124 included in backup data store 118 can represent a restorable backup of the full amount of data added to the blog over the years in which user 108 utilized online service 106 to publish his or her blog. In addition, archived data 124 can provide versioning such that a viewable version (discussed infra in connection with FIG. 2) or restorable version (detailed in connection with FIG. 3) of the blog can be provided in the state the blog existed at substantially any time in the past. Furthermore, archived content 124 (or copies or versions thereof) can be propagated (e.g., by way of propagation component 110) across a set of devices associated with user 108, which is further discussed in connection with FIGS. 3 and 4.

Backup data store 118 can be a network-accessible store, potentially as part of an online or cloud backup service that can be subscribed to by user 108. Operations detailed herein in connection with backup (or synchronization . . . ) can be provided from the online service 106 in a constant manner or by way of an “on-demand” procedure. For example, on demand operations can be employed to allow user 108 to, e.g., backup data from a given online service 106, which can be a one-time command to transfer data to backup data store 118. Additionally or alternatively, ongoing operations can be persisting in the background as an automated process such that data operations can occur when changes in online data 112 are noted. In certain aspects, if changes are too frequent, or the feature is otherwise desirable, a schedule that backs up online data 112 according to defined intervals can be implemented as well. Hence, based upon the granularity of updates to online content 112, settings, potentially defined by user 108, can be employed for determining various backup, synch, or restore operations (e.g., automatically upon a detected update of a certain granularity, a scheduled interval, or on-demand). In practice, at least for many sites, various updates can be automatic, yet user 108 can retain ability to specify non-default characteristics and certain configuration settings can be made on a service-by-service (e.g., online service 106) basis.

In accordance therewith, for example, on a first access to store 104 by connection component 102, propagation component 110 can download substantially all online content 112 currently present in store 104, potentially by employing credentials associated with user 108 or by way of an access agreement between backup service 122 and online service 106 along with authorization from user 108. In that case, recent version 120 can be a duplicate of substantially all online content 112. However, upon subsequent accesses to store 104, backup component 116 can, e.g., compare online content maintained by store 104 to one or more existing versions of archived content 124 included in backup data store 118. Accordingly, backup component 116 can then identify a particular portion (e.g., portion 114) of online content 112 that differs from an existing version of archived content. Based upon this comparison, propagation component 110 can determine or be instructed to download only the portion that differs, which backup component 116 can archive as recent version 120.

It should be understood that previous literature often defines “backup” or similar terms as a relatively short-term scheme in which backed up data is retained only for a short time and subsequent versions overwrite previous versions. In contrast, the term “archival” or similar terminology usually refers to a longer-term scheme in which data is backed up for very long periods and numerous versions of the data are retained. As used herein, backup, archive, and archival are used interchangeably and intended to refer to ongoing, versioned, and long-term storage of data that previous literature tends to ascribe to the term “archival.”

It should be further understood that the claimed subject matter can be implemented according to a variety of different architectures or topologies. In particular, all or portions of system 100, as well as other components described herein can be included in a network-accessible online mesh or cloud service, potentially as part of backup service, which will typically be remote or distinct from online service 106 or devices local to or associated with user 108. Additionally or alternatively, all or portions of system 100, as well as other components described herein can be included in a device local to or associated with user 108. In the former case, credentials associated with user 108 can be distributed to a system or service that maintains system 100, while in the latter case, upon proper authorization from user 108, system 100 can have ready access to the credentials of user 108. Moreover, archived content 124 (or copies or versions thereof) can be stored to a device associated with user 108, yet with metadata pertaining to that content residing in backup data store 118. Hence, various data quota schemes or size limitations can be handled for the benefit of user 108.

Turning now to FIG. 2, system 200 that can provide an aggregated view of online content from multiple sources is illustrated. In general, system 200 can include backup data store 118 that can stored as archived content 124 online content 112 maintained by online service 106 as substantially described supra. As depicted, in one or more aspects of the claimed subject matter, backup data store 118 can receive online content 112₁-112_{N} (hereinafter referred to either collectively or individually as online content 112) from multiple stores 104₁-104_{N} (referred to collectively or individually as store(s) 104), where N can be substantially any positive integer. Thus, each online service 106₁-106_{M} (referred to individually or collectively as online service(s) 106), where M can be substantially any positive integer less than N. In other words, each online service 106 can have one or more store 104, and for each store 104, a particular set of online content 112 associated with user 108 can be provided to backup data store 118 as archived content 124 associated with user 108.

Moreover, system 200 can include interface component 202 that can provide view 204 archived content 124. View 204 can be provided to, e.g., user display 206, which can be substantially any display device and can be associated with user 108 such as a screen or monitor for a device employed by user 108. In one or more aspects of the claimed subject matter, view 204 can present one or more content version 208 of archived content 124 that is imported from a single online service 106. Additionally or alternatively, view 204 can present one or more content version 208 of aggregated archived content 210 that is aggregated from multiple online services 106.

Thus, view 204 can be that of a single version 208, either a most recent or an older version 208, of content from a single online service; multiple versions 208 from a single online service 106; a single version 208 of an aggregated content view 210; an aggregated content view 210 with multiple content versions 208; or combinations thereof. Appreciably, the claimed subject matter can therefore provide a convenient portal for many services employed by user 108, yet without altering or interfering with an experience associated with any given online service 106. In particular, user 108 can still manually log into any online service 106 desired and interact as he or she normally would with that service. However, user 108 can also have access to online content 112 from multiple online services 106 simultaneously should such a presentation be preferred, and without switching windows or performing multiple login procedures.

Furthermore, adding content or other changes to online content 112 can be performed directly from the view 204. Such changes can be automatically applied to archived content 124 and can also be propagated back to one or more online services as is further detailed below in connection with FIG. 3. Moreover, it should be appreciated that interface component 202 can be included in or operatively coupled to system 100 and/or one or more components included therein or described herein.

With reference now to FIG. 3, system 300 that can, inter alia, restore content to online services is provided. In particular, system 300 can include restore component 302 that can select from backup data store 118 archived content 124 or a portion thereof, which is labeled as reference numeral 304. Content portion 304 can be online content 112 associated with user 108 that was previously archived as detailed supra, and that is designated for restoration operation 306. Consequently, propagation component can export content portion 304 in accordance with restoration operation 306. For example, content portion 304 can be exported to online service 106 from which that content was originally imported, say, in the event the online service 106 lost some user data. Additionally, content portion 304 can be restored to store 310 associated with disparate online service 308, e.g., in the event that the original site scales back or shuts down and user 108 needs a new milieu for his or her content, or simply decides to switch because of a preference. Furthermore, content portion 304 can also be restored to user device 312, which can be a device or component thereof that is local to user 108.

It should be appreciated that in some cases, a format associated with one online service might differ from that for another restoration destination, or even that for backup data store 118. These differences in formats can be related to a file format of the data or to a scope associated with online service 106. Scopes are further detailed infra in connection with FIG. 4, but as a brief introduction, a scope is intended to refer to a grouping of related data that is particular to a certain online service 106 and/or the associated store 104. For example, consider that one online service 106 that focuses on sharing photos might expose albums and/or galleries as a scope, whereas a second online service 106 that focuses on storing and sharing files might expose folders or drives as a scope.

Therefore, system 300 can further include content converter component 314 that can receive content portion 304 and output corresponding converted content 316 that is suitable for the destination of the content. Appreciably, although depicted here in connection with a pushing data from backup data store 118 to other destinations (e.g., back to store 104, to disparate store 310, or user device 312), it should be understood that content converter component 314 can also be employed when populating backup data store 118, and can thus be utilized in connection with content portion 114 described with reference to FIG. 1. In particular, content converter component 314 can convert a data format associated with online content 112 or with archived content 124 into a disparate data format that is suitable for the destination. Likewise, content converter component 314 can convert a scope associated with online service 106 that hosts online content 112 to a disparate scope associated with disparate online service 308 or to a disparate scope associated with backup data store 118.

Regardless, propagation component 110 can export converted content 316 (e.g., content with a converted file format or scope) to the desired destination, or import converted content 316 to be archived to backup data store 118 by backup component 116. In addition to being employed in connection with backup component 116 and restore component 302, content converter component 314 can also be utilized in connection with synchronization component 318, which can now be described.

Synchronization component 318 can select from backup data store 118 content portion 304 (or other archived content 124 associated with user 108). In addition, content can also be selected by synchronization component 318 from store 104 associated with online service 106, as depicted by the broken line. Regardless, the selected content, be it archived content 124 or online content 112 can be content that is designated for synchronization operation 320. Similar to that described above in connection with restoration operation 306, propagation component 110 can export (or import when backing up) the archived content 124 or the online content 112 that is slated for synchronization operation 320, which, can be converted content 316. As introduced above, archived data 124 included in backup data store 118 can be provided as well as copies or versions thereof can be stored across devices owned, operated, or managed by user 108, which can, e.g., increase overall redundancy. Moreover, various statistical measure for determining best placement can be employed. For example, copies or versions of all or portions of archived content 124 can be distributed to various devices associated with user 108 based upon cost efficiency, latency efficiency, available peers, health, location, capacity, and so on.

It should be apparent that the architecture for restore component 302 and synchronization component 318 can be similar, with operations performed by these components differing in terms of restoration versus synchronization. Furthermore, it should be understood that restore component 302, content converter component 314, and synchronization component 318 can be included in or operatively coupled to system 100. More particularly, all or portions of these components 302, 314, 318 can be included in backup component 116 as is illustrated by the dashed box labeled backup component 116 that encompasses the above-mentioned components. Given that the structural architecture to facilitate archiving, restoring, and synchronizing can be similar, additional detail and features are described below with reference to FIG. 4 in the context of synchronization, however, it should be understood that these aspects or features can be applicable to archiving and restoring as well.

Turning now to FIG. 4, system 400 that can facilitate synchronization of online or archived content by way of a cloud synchronization service is depicted. Thus, system 400 can represent more detail in connection with what has been described above in connection with synchronization component 318, with various features applicable to backup component 116, restore component 302, and content converter component 314. However, prior to describing the cloud synchronization service of FIG. 4 in detail, descriptions of terminology employed for the remainder of the disclosure are in order. Generally:

“Community” is intended to relate to a set of replicas that are synchronizing (or restoring or archiving) a particular scope of data.

“Public data” is intended to relate to data published by a user or a content provider, accessible to the general public through a site or online service. Thus, public data can be analogous to online content 112 or archived content 124. Examples can include public photos, music and videos, as well as blogs, news feeds, contact lists, or other objects.

“Replica” is intended to refer to the set of data and/or metadata that represents a single store's synchronized copy of a particular scope of data.

“Scope” is intended to relate to a grouping of related data items exposed and maintained by a particular store. Examples can include a photo album on a photo storage site, or a folder on a file storage site, or a list of recommendations on a shopping recommendation site.

“Site” (also online service, e.g., online service 106 or disparate online service 308) is intended to refer to an online repository of public data or user data (or both). Sites typically group user data into scopes and may expose data for programmatic access through an API.

“Site permission” is intended to relate to a permission grant from an online service or site to a developer for use with the site's API. In the case of cloud synchronization service, this can represent a permission grant to the cloud synchronization service itself.

“Store” is intended to relate to a collection of data maintained at a site, exposed through a data access API, and can be substantially similar to stores 104, 310 detailed supra.

“User data” is intended to refer to data published by or stored on behalf of a particular user (e.g., user 108) by a site, typically accessible only to that user or, through sharing, to other authorized users, applications, and/or services. Examples can include files, photos, personal recommendations, and lists.

“User permission” (also delegated permission or delegated authorization) is intended to refer to a permission grant from a site or online service to a developer for use in interacting with a specific user's data through the site's API.

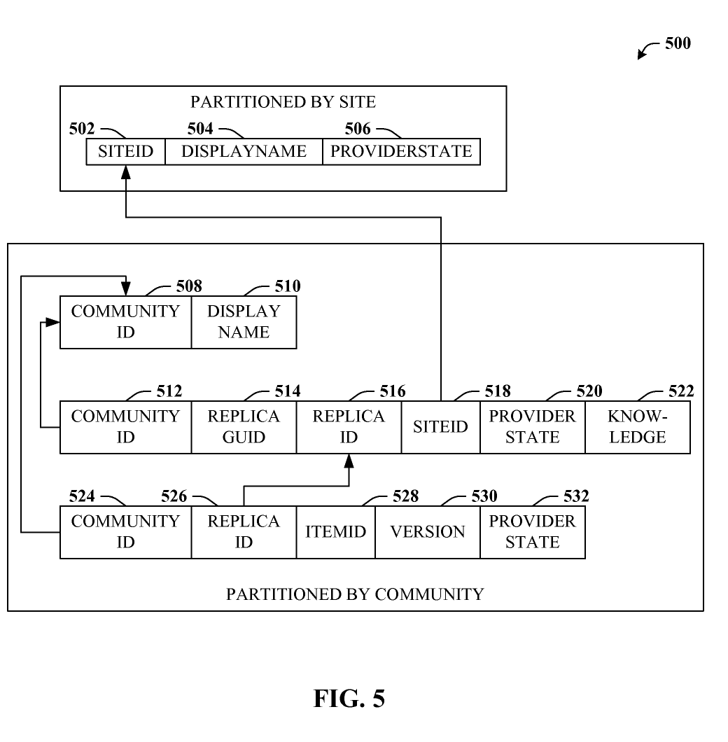

Continuing the discussion, system 400 can include sites store 402 that can be a database or store of information and/or credentials for each site 106 that is supported by the cloud synchronization service described by system 400. Sites store 402 can include the uniform resource identifiers (URI) for each site's API endpoints, as well as credentials for communicating with the site 106 through its security and authorization protocols. Generally, all tables can be partitioned by a site identifier that is discussed in more detail with reference to FIG. 5

System 400 can also include one or more site proxy nodes 404 that can be facilitate or manage communication with one or more external sites 106. For example, each site proxy node 404 can aggregate outgoing requests to a site 106 over one or more long-lived connections. In addition, each site proxy node 404 can expose hypertext transfer protocol (HTTP) endpoints that can be used as sinks for incoming change notification requests. Typically, all site proxy nodes 404 can be partitioned by the site identifier.

Next to be described, system 400 can include synch communities store 406 that can store information for each synchronization community that's being actively maintained by the service. For instance, for each community, synch communities store 406 can identify the participating replicas and their associated sites 106. Normally, all tables included in synch communities store 406 are partitioned by a community identifier discussed in connection with FIG. 5.

Likewise, system 400 can also include replica metadata store 408 that can store the synchronization knowledge that the service is maintaining for each replica. Replica metadata store 408 can contain a table whose rows list the knowledge for each replica, as well as a table whose rows optionally contain item-level metadata for each replica. Generally, all tables included in replica metadata store 408 are partitioned by the community identifier. It should be further appreciated that stores 402, 406, and 408 can be included in or operatively coupled to backup data store 118 detailed supra.

In addition, system 400 can also include synch manager 410, which can be a component of or an extension of synchronization component 318 or restore component 302 (or backup component 116). Synch manager 410 can be responsible for one or more synchronization communities. Accordingly, for each replica in a community, synch manager 410 can either poll for updates or issues change notification requests through the site proxy node 404 for the replica's site 106. As updates are detected, synch manager 410 can schedule synchronization sessions on the set of sync worker nodes 412 in the associated cluster. These synch worker nodes 412 can be responsible for executing synchronization logic on demand for a set of replicas in a community. Thus, synch worker nodes 412 can invoke site 106 access APIs through site proxy nodes 404 to, e.g., bring replica metadata up to date and/or propagate updates across various replicas.

As a working model for synchronization (or backup or restore), two related concepts that were defined above should be called out for the sake of conceptual understanding, but is further detailed in connection with FIG. 5:

A replica can be a set of data and associated metadata that represents one endpoint's synchronized copy of a particular scope of data. Examples might include a photo gallery on a photo sharing site, or a document library on a virtual web site that facilitates collaboration, communication, or content storage; and

A community that can be a set of replicas that are synchronizing a particular scope of data amongst one another. Examples might include the set of devices that are replicating a given a sharing and synchronization platform folder or, perhaps more interestingly, a sharing and synchronization platform folder that's set to also synchronize with a photo gallery on a photo storage site.

At a basic level, the claimed subject matter, say, in the context of a cloud synchronization service can deliver the ability to define a synchronization community and then add replicas to that community, where a given replica can correspond to a store on any supported online service 106. Once a community is defined, the cloud synchronization service can handle synchronizing, restore, or backup of data across all suitable replicas, where replicas can potentially be stored on any device associated with user 108.

The cloud synchronization service can effectuate executing data synchronization logic on an ongoing basis using a pool of synch worker nodes 412, scheduling data transfers across a pool of site proxy nodes 404. Such can be accomplished by relying on either polling or change notifications to drive the data synchronization logic, depending on which is supported by a given online service 106. In addition, synch worker nodes 412 can facilitate data transfers based upon an “on-demand” scheme, e.g., based upon an explicit input or command by user 108 or a proxy.

The cloud synchronization service can also handle maintaining metadata for each replica, which may vary in size depending on how much native change tracking support is provided by a given replica's store. This metadata maintenance can effectively allow enabling of synchronization with respect to substantially any arbitrary store, in some cases at the expense of manufacturing item versions to track ongoing changes.

In order to interact with stores, there are a number of issues that must be provided for, such as issues relating to permissions, scopes, and data representations. Appreciably, there is no uniform mechanism for interfacing to every major or important online service 106. Rather, each online service 106 typically exposes a different API for gaining access to the data that it stores on behalf of user 108.

Such diversity of APIs poses a challenge for building a broadly applicable cloud synchronization service. Addressing these challenges can involve defining store access mechanisms that are abstract enough to apply across a broad range of online services, while also being concrete enough to expose the functionality needed by a common synchronization engine. One aspect of meeting those challenges can relate to defining common access mechanisms that each store 104 should expose. However, the cloud synchronization fabric should also be configured to meet other challenges presented.

In the case of managing permission, online services 106 typically require authorization before granting access to user data. In order to synchronize data from a site on a user's behalf, the cloud synchronization service should understand and implement the permissions scheme for the particular site 106, as well as storing the necessary credentials for use on an ongoing basis.

Fortunately, there are broad similarities between the permissions schemes that are currently in use across the most popular sites 106. In addition, many sites 106 are adopting standard schemes like OAuth, which further simplifies the task of authorizing access across multiple sites. Moreover, the cloud synchronization service can provide built-in support for the permissions schemes used by the most popular sites 106. Furthermore, the service can provide a mechanism for developers to add support for new permission schemes and make that support available for use by other developers.

Continuing, another difficulty that must be addressed relates to defining the scope of data synchronization (or restores or backups). In particular, each online service 106 typically has a unique way of grouping user data into scopes. For instance, an online service for storing and sharing photos might expose galleries as a scope, in addition to collections of favorite photos. Similarly, a site for storing and sharing files might expose folders or drives as a scope. Thus, the cloud synchronization service can suitably map the scopes defined by one site 106 to corresponding scopes defined by other sites 106, in order to synchronize the scopes with one another other.

In addition, multiple data representations can be provided for as well. For example, user 108 generally has a simple mental model for basic kinds of data like photos, files and folders, music, and so on. However, each online service 106 might very well have a unique way of representing those types of data. In order to synchronize disparate online services within the same community, the cloud synchronization service can transform the representations of data.

For the most part, the services 106 might not differ too significantly in how each represent the most common data types. Thus, often it can be sufficient to directly map fields in one site's schema to corresponding fields in another site's schema. While such is generally suitable for many of the most common data types, in order to maintain data fidelity and to avoid unexpected results with less common data type can require specification of mappings on a case-by-case basis.

The convention across most online services 106 is to represent data types using JavaScript Object Notation (JSON) or one of several extensible markup language (XML)-derived representations. The cloud synchronization service can take advantage of these uniformities to mitigate many data transformation challenges, e.g., by providing a library of pre-defined extensible stylesheet language transformations (XSLT) that operate to convert between the service-specific representations of the most popular data types across the most popular online services 106. These features can be included in or provided by content converter component 314. Moreover, the replicas in each synchronization community can then be restricted to those sites 106 whose data types are mutually compatible given the set of available transformations. Furthermore, developers can be provided that ability to extend this library of transformations in order to create new communities of mutual compatibility among online services.

It should be appreciated that when managing data transfers, the cloud synchronization service can be processing potentially large amounts of data, moving this data around on an ongoing basis on behalf of users 108, applications, and online services 106. Such capability can first be designed for and applied to the highest-value scenarios, and in those scenarios the capability can cost-beneficial, either by powering a premium experience or as part of a platform that supports revenue-generating applications and online services 106.

At the same time, a number of other techniques can be important for providing this data transfer capability efficiently and at massive scale. These can include:
Geo-distribution of the nodes used by the cloud synchronization service, so that the synchronization or data transfer logic can run close to the sites for each community's replicas.
Batching of data transfer connections, to ensure that transfers into and out of popular online services 106 are performed efficiently and, potentially, over dedicated paths
Differential encoding for data transfers, to ensure that a small change to a large content item doesn't require the entire content item to be re-transferred.
Off-peak scheduling of data transfers that don't require immediate synchronization, to take advantage of spare bandwidth capacity in associated datacenter networks.

In addition, allowances can be made for partitioning for scalability. For example, in order to control load placed on external sites 106 as well as to take advantage of reuse over long-lived connections, it can be desirable to have a single set of machines communicating with any one external site 106, while another set of machines communicates with a second external site 106. At the same time, in order to efficiently execute synchronization among the replicas that participate in a given synch community, it can be desirable to store all the replicas for a community in the same storage partition of synch community store 406.

The first consideration potentially suggests that replica information should be partitioned by site 106, as such a partition will generally ensure that a single partition is communicating with an external site 106 for all the site's replicas. However, the second consideration largely suggests that replica state should be partitioned by community, as that type of partitioning will likely locate all the replicas for a community in the same partition.

Clearly, these two considerations place conflicting demands on the partitioning policy of system 400. However, the above-mentioned conflict can be resolved by way of the following approach. First, strongly partition replica state by community, yet weakly partition data transfers by site.

Accordingly, by strongly partitioning replica state by community, each replica has a home partition that is based on its community's identifier. Furthermore, all the replicas for a community can have the same home partition. Thus, when a synchronization session is underway for a set of replicas, all the database updates for that session can occur within the same partition. Moreover, by weakly partitioning data transfers by site, when a synchronization session is underway for a set of replicas, the node handling the session communicates with the external site 106 for each replica through a node that's weakly bound to the site 106 based on its site's identifier, that's optionally ‘close’ to the site in the network topology, and that batches requests to that site over a long-lived connection. These and other features are further detailed in connection with FIG. 5.

In accordance therewith, it should be appreciated that, conceptually, the cloud synchronization service can provide a web-based experience where a user or developer can set up a synch community manually or programmatically, by, e.g., selecting from a list of supported sites and/or online services 106. Each site 106 added can become a replica associated with the community. If the replica for a site 106 requires the user permission, the user 108 can be directed through the permissions web experience for the site 106, resulting in permission being granted to the cloud synchronization service. The resulting synch community, the associated list of replicas, and their corresponding permissions can then be persisted in a backend store (e.g., site store 402, which can be included in backup data store 118) for the cloud synchronization service Moreover, the cloud synchronization service can incorporate synch manager 410 in each storage partition that can monitor all or a portion of active synch communities in the partition, scheduling synchronization sessions on those partitions as needed, e.g., based on the change rate and any incoming change notifications. Synch Manager 410 can request change notifications from the site 106 for each replica, in cases where site 106 supports change notification. Additionally, when synch manager 410 determines that a synchronization session is needed to bring a particular synch community up to date, synch manager 410 can schedule a job on the cloud synchronization service's on-demand compute fabric.

Additionally or alternatively, when a synch worker node 412 executes to handle a synchronization session for a synch community, worker node 412 can enumerate all or a portion of the replicas that comprise the community. Thus, for each replica, synch worker node(s) 412 can instantiate a store access provider that can communicate with the underlying store (e.g., replica metadata store 408) of the replica. Synch worker node 412 can then invoke the store access providers to bring each replica's metadata up to date.

Once the replica metadata is updated, the replicas can then be synchronized, and updates can be exchanged amongst them. The resulting set of updates can be pushed out to the store for each replica, including insertions, updates and removals of items as well as upload and download of associated content. Appreciably, the process of bringing a replica's metadata up to date may involve pushing or pulling data across widely dispersed geographical locations. Thus, in order to exploit network proximity and maximize connection reuse, the cloud synchronization service can operate a fabric of proxy server nodes 404 that can be partitioned by site identifier. Hence, when a synch worker node 412 chooses to interface to a site 106, the worker node 412 can dynamically discover the site's proxy node 404 and send, e.g., a HTTP requests through that particular proxy node 404. Appreciably, a similar method can be employed in connection with various devices associated with user 108.

While still referring to FIG. 4, but turning now also to FIG. 5, diagram 500 illustrates relationships between the various elements associated with a backup, restore, and/or synchronization storage model. The upper-most row can relate to a sites table that is partitioned by site (e.g., site 106), and which can be utilized to track information about each online service 106 that is supported by the cloud synchronization service discussed in connection with FIG. 4. In particular, the sites table can include a column for SiteID 502 that can be an int data type as well as a primary key. SiteID 502 will typically refer to a system-wide identifier for a particular site 106. Moreover, an associated value included in SiteID 502 can be employed to derive a partitioning key for the sites table. Appreciably, various versions of archived content 124 can be defined by or stored within metadata included in synch community store 406.

The sites table can also include a column labeled DisplayName 504. DisplayName 504 can be a nvarchar(80), not null data type. DisplayName 504 can be a human-readable display name for the site. Next, the sites table can also include a column for ProviderState 506, which can be varbinary(1024) data type. ProviderState 506 can be an opaque state that is maintained on behalf of the store access provider for the site 106. Typically, ProviderState 506 will include site-level settings such as site URIs, permissions granted to the cloud synchronization service or the like.

The lower block includes three tables that can be partitioned by community. These tables in descending order relate to a communities table (e.g., columns 508 and 510), a replicas table (e.g., columns 512-522) and a replica item metadata table (e.g., 524-532). The communities table can track information about each synchronization community that is maintained by the cloud synchronization service. The communities table can include a column for CommunityID 508 that can be a bigint data type and can also be a primary key. CommunityID 508 can relate to a system-wide identifier for a particular community, and the corresponding value can be employed to derive the partitioning key for the communities table as well as other related tables. In one or more aspects CommunityID 508 can be based on the owning PUID so that a particular user's replicas can be stored near the user's storage partitions and mesh objects. Regardless, the column headed by DisplayName 510 can refer to a nvarchar(80) data type, and can be an optional human-readable display name for the community.

Continuing to the next row, the replicas table can track information about each replica that is undergoing a synchronization (or backup or restore) operation performed by the cloud synchronization service discussed supra. The replicas table can include a column for CommunityID 512 that can be a bigint data type and can also be a primary key. CommunityID 512 can relate to a system-wide identifier for a particular replica's community, and the corresponding value can be employed to derive the partitioning key for the replicas table.

Furthermore, the replicas table can also include a column for ReplicaGuid 514 that can be a guid data type and can also be a primary key. Replica Guid can be a globally unique identifier for the instant replica. Similarly, ReplicaID 516 can be an int data type and also a unique identifier. ReplicaID 516 can be, e.g., a 32-bit identifier for the replica that can be employed in tracking item metadata.

In addition, the replicas table can include a column for SiteID 518 that can be an int, not null data type, which can refer to the site or online service 106 to which the instant replica corresponds. The ProviderState 520 column can be a varbinary(1024) data type in which an opaque state can be maintained on behalf of the store access provider for the online service 106 to which the instant replica corresponds. Such can include replica-specific settings such as URIs for the scope being synchronized, permissions granted by user 108 and so forth. The final example column depicted by the replicas table is KnowledgeBlobReference 522, which can be an uri data type and represent a reference to a blob containing synchronization knowledge for the replica.

In the third and final table, the replica item metadata table, five columns are provided in this example. The replica item metadata table can track information about individual item versions for replicas that are being synchronized by the cloud synchronization service. This table can contain versions only for those replicas whose corresponding site 106 does not natively support change tracking. The replica item metadata table can include CommunityID 524, which can be a bigint data type and can also be a primary key. CommunityID 524 can also be a system-wide identifier for the community containing the replica in which the instant item appears. The associated value of CommunityID 524 can be employed to derive the partitioning key for the replica item metadata table.

In addition, a column for ReplicaID 526 can be provided as well. ReplicaID 526 can be an int data type. ReplicaID 526 can also be a primary key such as a 32-bit identifier for the replica to which the item corresponds. Continuing, ItemID 528 can be a guid data type as well as a primary key. ItemID 528 can thus be a globally unique identifier for the item. Furthermore, the particular version of an item can be described by the column headed by Version 530, which can be a varbinary(48), not null data type. The last column in this example replica item metadata table is ProviderState 532, which can be a varbinary(8192). ProviderState 532 can be an opaque state maintained on behalf of the store access provider for the replica.

Hence, with the above in mind, and continuing the discussion of FIG. 4, it should be appreciated that synch manager 410 can facilitate a service that relies on the site client access library for communicating with online services 106 when issuing change notification requests. Moreover, this service can interact with synch worker nodes 412 when scheduling synchronization sessions.

Moreover, synch worker nodes 412 can rely on store access providers for interacting with data managed or maintained by online services 106, whereas synch worker nodes 412 can also rely on a synchronization framework (e.g., SyncFX) for orchestrating synchronization sessions. Synch worker nodes 412 can also rely on data transformation libraries for converting data between compatible formats across online services 106 during synchronization sessions.

Furthermore, the SyncFX can interact with the store access provider for each replica while orchestrating synchronization sessions. Additionally, the SyncFX can rely on a partitioned replica item metadata storage service for retrieving and persisting replica item metadata while synchronizing replicas. Thus, each store access provider can rely on the site client access library for communicating with the online service 106 to which a replica corresponds. And, the site client access library can rely on the permissions library for managing site and user permissions when communicating with online services.

In more detail, a permissions framework library can be established. For example, the cloud synchronization service can incorporate an extensible framework for managing the site and user permissions that are used to interact with online services 106 while synchronizing replicas. Such a framework can be used by the experiences that enable users and developers to configure synchronization communities, as well as by store access providers when interacting with the site APIs for the replicas that they synchronize.

The permissions framework library can consist of a set of managed classes which are described infra. Thus, a permissions manager can be employed such that an initial static class can be the starting point for working with the framework. The initial static class can provide static methods for serializing and de-serializing permissions and site settings and/or for instantiating the state and logic associated with a site's permission scheme.

Moreover, permission can be based upon an abstract base class for all site and user permissions. However, the permissions scheme can be based upon a class that is an enumeration of the permission schemes supported by the site permission library. Previous, known examples, some of which relate to well-known online services, include, e.g., FlickR, LiveID, OAuth, OAuth-Photobucket, OAuth-Google, OAuth-Smugmug, etc.

Permission Scheme Site Settings can be an abstract base class, each of whose descendants encapsulates the settings associated with a particular permission scheme on a particular site. For instance, any site that implements an OAuth-based permission scheme will have site settings that include a request token URI, a user authorization URI, and an access token URI.

Likewise, Permissions Scheme Context can be a class that encapsulates the state and logic associated with a specific site 106 or user permission grant. Permissions Scheme Context can provide methods for obtaining user permissions by executing the logic defined by a site's permission scheme and signing outgoing requests using site or user permissions obtained through a site's permission scheme.

In addition, a store access provider framework library can be provided as well. For example, the cloud synchronization service can incorporate an extensible framework for interacting with sites and online services 106 through their associated APIs in order to, e.g., synchronize replicas of the data (e.g., online content 112) that is managed or maintained. The store access provider framework library can consist of one or more of the following elements:

(1) Site client classes. Site client classes can be derived from the previous frameworks, which can define a set of managed classes (e.g., HttpClient and HttpOperationContext) for interacting with HTTP services. These previous frameworks can extends these classes with native support for communicating through site proxies and for signing outgoing requests using site and user permissions.

(2) Synchronization and metadata storage classes. Synchronization and metadata storage classes can be derived from the Synch Framework provider framework, which can define a standard set of managed classes for enabling synchronization of stores and for storing replica metadata. The Synch Framework provider framework can extend these classes with support for serializable provider state, partitioned replica metadata storage, or data transformation support.

Furthermore a data transformation library can be provided, which can contain a collection of built-in, pre-compiled XSLTs for the data formats supported by the cloud synchronization service. Such data transformations can be invoked dynamically by synch worker nodes 412 during synchronization or other operations when item data are exchanged between replicas

With respect to synch manager 410, various service elements such as a synch manager service can be provided. For instance, synch manager 410 can be or facilitate a service application that executes on the non-Internet-facing machines that host the cloud synchronization service. Synch managers 410 can be responsible for coordinating the overall process of keeping replicas up to date for each synch community. Moreover, each instance of the synch manager service can be responsible for one or more partitioning keys in the synch communities table. Thus, upon initialization, a synch manager service instance can discover which synch communities to manage or otherwise be responsible for. Therefore, these synch manager service instances can initiate operation for each subordinate synch community.

Moreover, for each replica in a synch community, synch manager 410 can register for change notification (if available), and can further schedule a synchronization session to bring the replica up to date. If the site 106 for a replica does not support change notification, then synch manager 410 can establish a periodic polling interval for the replica. Appreciably, synch manager 410 can reference the site client library for all or a portion of site 106 communications.

With respect to synch worker nodes 412, various synch worker services can also be provided. In particular, a synch worker can be a service application that executes on the non-Internet-facing machines that host the cloud synchronization service. Sync workers can be responsible for executing on-demand synchronization sessions between replicas in a synch community. Furthermore, each instance of the sync worker service can be responsible for continuously de-queuing pending synchronization sessions scheduled by synch managers 410. Each synchronization session can involve a single community. Thus, upon initialization, a sync worker can executes the following logic: (1) Instantiate store access providers from the provider state serialized for each replica; and (2) Invoke the Synchronization Framework (e.g., SyncFX) orchestration logic to synchronize the replicas using the store access providers.

Turning to the site proxy nodes 404, in more detail, site proxy nodes 404 can also provide various services. In particular, a site proxy service can be a service application that executes on the Internet-facing machines that make up the cloud synchronization service. Site proxies can be responsible for aggregating outgoing requests to online services over long-lived HTTP connections, as well as for providing HTTP endpoints that can be used as sinks for incoming change notifications from online services.

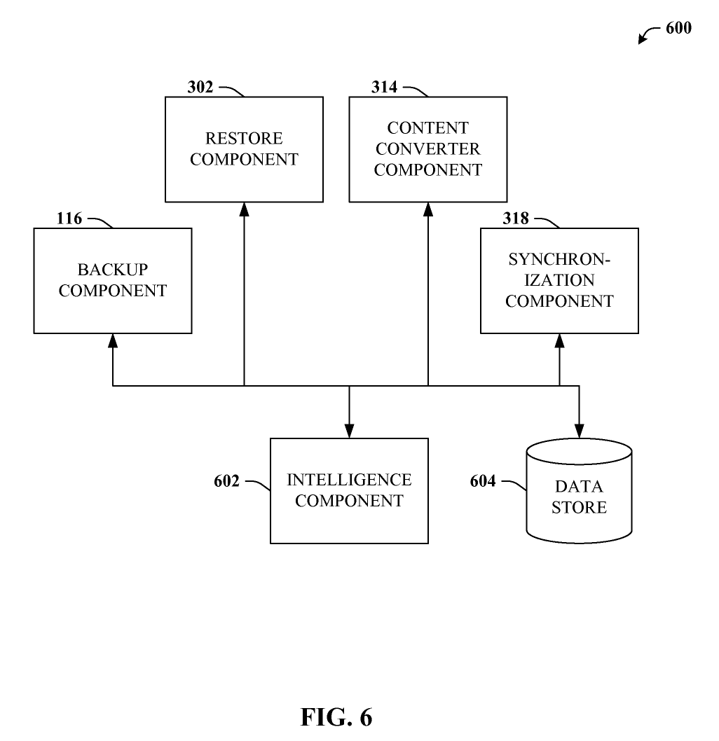

Referring now to FIG. 6, system 600 that can provide for or aid with various inferences or intelligent determinations is depicted. Generally, system 600 can include all or portions of system 100, such as backup component 116, restore component 302, content converter component 314, and synchronization component 318 as substantially described herein. In addition to what has been described, the above-mentioned components can make other intelligent determinations or inferences. Appreciably, any such inference or intelligent determination can potentially be based upon, e.g., Bayesian probabilities or confidence measures or based upon machine learning techniques related to historical analysis, feedback, and/or previous other determinations or inferences.

In addition, system 600 can also include intelligence component 602 that can provide for or aid in various inferences or determinations. In particular, in accordance with or in addition to what has been described supra with respect to intelligent determination or inferences provided by various components described herein. For example, all or portions of system 100 can be operatively coupled to intelligence component 602. Additionally or alternatively, all or portions of intelligence component 602 can be included in one or more components described herein. Moreover, intelligence component 602 will typically have access to all or portions of data sets described herein, which can be maintained by data store 604.

In accordance with the above, in order to provide for or aid in the numerous inferences described herein, intelligence component 402 can examine the entirety or a subset of the data available and can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data.

Such inference can result in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

A classifier can be a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

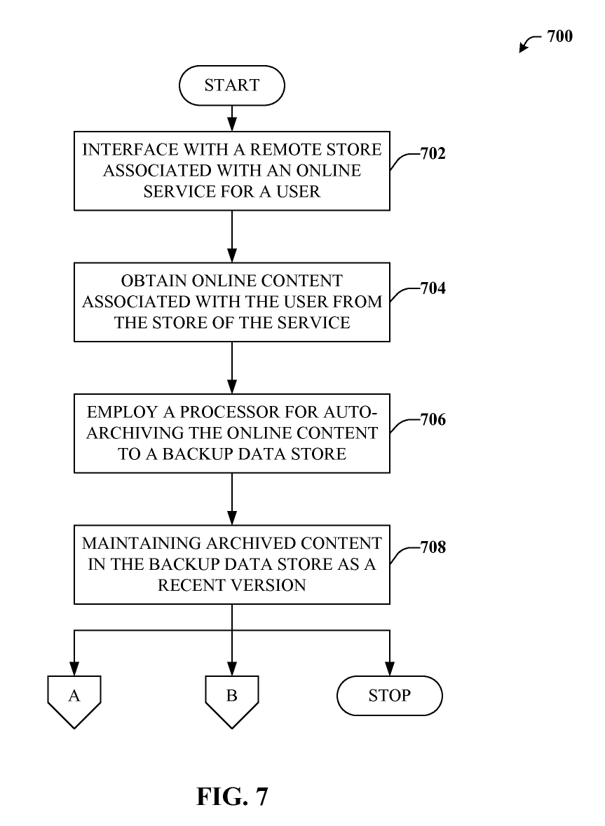

FIGS. 7, 8, and 9 illustrate various methodologies in accordance with the claimed subject matter. While, for purposes of simplicity of explanation, the methodologies are shown and described as a series of acts, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

With reference now to FIG. 7, exemplary computer implemented method 700 for facilitating automatic backup and versioning of online content is provided. Generally, at reference numeral 702, a remote store associated with an online service can be interfaced with on behalf of a user of the online service. In other words, a connection session can be established on behalf of the user in order to effectual an automatic backup of content such as content the user publishes to the online service.

Moreover, at reference numeral 704, online content associated with the user can be obtained from the remote store managed by the online service. For example, the online content can be obtained by way of the connection established with reference to reference numeral 702. Accordingly, at reference numeral 706, a processor can be employed for automatically archiving the online content to a backup data store. Appreciably, the online content that is archived can be stored in accordance with versioning of the content such that various version of the online content can be stored simultaneously as versioned archived content. Thus, at reference numeral 708, archived content can be maintained in the backup data store as a recent version of the online content.

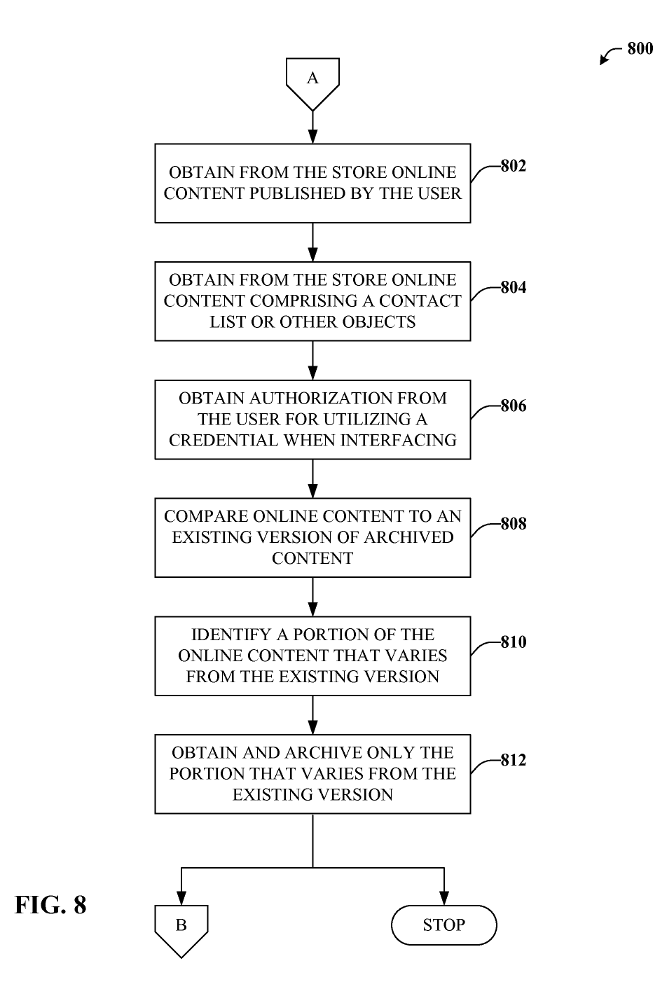

Referring to FIG. 8, exemplary computer implemented method 800 for providing addition features in connection with facilitating automatic backup and versioning of online content is depicted. At reference numeral 802, social networking-oriented online content published by the user can be obtained from the store in accordance with reference numeral 704. In other words, the type of online content obtained can specifically relate to networking-oriented content published by the user, such as blogs, news feeds, messages, description, and so on.

At reference numeral 804, online content comprising one or more contact list or objects associated with the user, one or more layout or schema associated with the online content, as well as metadata associated with the online content can be obtained from the store. In this case, the online content obtained is specifically directed to lists, objects, or metadata. Furthermore, at reference numeral 806, authorization from the user can be obtained for utilizing a credential associated with the user. Hence, acquiring the credential can authorize and simplify the interfacing with the remote store detailed in connection with reference numeral 702. Appreciably, authentication of the user can be provided in connection with either proprietary or open standards.

Moreover, it should be appreciated that not all online content need be acquired during a particular connection session and/or data transaction. Rather, at reference numeral 808, online content maintained by the online service can be compared to an existing version of archived content (generally the most recent version) included in the backup data store. Thus, at reference numeral 810, a portion of online content that varies from the existing version can be identified so that, at reference numeral 812, only that particular portion is obtained and archived.

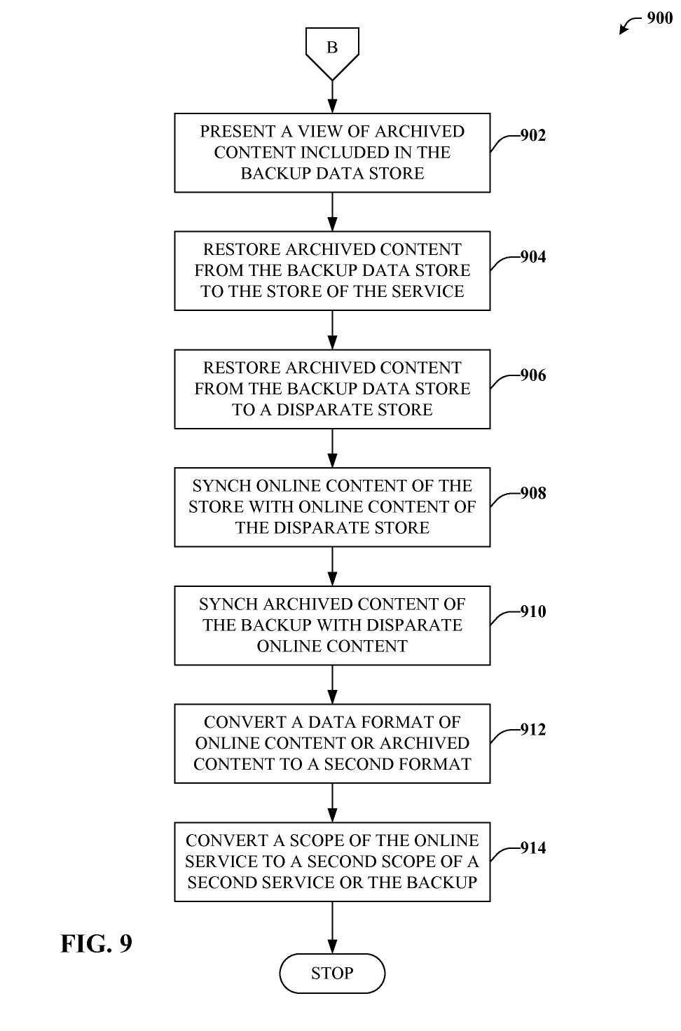

With reference now to FIG. 9, method 900 for providing for restoring or presenting views of archived content as well as converting or synchronizing either online or archived content is illustrated. At reference numeral 902, a view of archived content included in the backup data store can be presented. Appreciably, the view can be of a particular version of archived content (e.g., a version of online content as it currently exists or previously existed) from a single online service or multiple versions presented simultaneously. Furthermore, the view can also be an aggregate view including archived content from multiple online services, in a single or multiple version presentation.

At reference numeral 904, archived content from the backup data store can be restored to the remote store associated with the online service discussed in connection with reference numeral 702. Thus, content lost or removed from the original site can be repatriated back to that site. Moreover, at reference numeral 906, archived content from the backup data store can be restored to a second store associated with a disparate online service. Hence, online content from one online service can be duplicated to another site, which can be useful for replicating content across multiple sites with minimal effort on the part of the user, or when the original online service discontinues operations, or when the user chooses to switch online service providers.

Similarly, at reference numeral 908, online content managed by the online service can be synchronized with online content managed by a disparate online service. Thus, in addition to express backup operations, the user can designate in advance that online content published to one online service should be synchronously applied to other online services. Appreciably, at reference numeral 910, such synchronization can be due to changes originating in the backup data store or the backup data store itself can be synchronized from updates originating from a disparate online service. In particular, archived content included in the backup data store can be synchronized with online content managed by the disparate online service or even to a device associated with the user.

It should be understood that in all case detailed herein that involve data propagation, whether a backup operation, a restore operation, or a synchronization operation, various conversions upon the data can be employed. For example, at reference numeral 912, a data format associated with the online content or the archived content can be converted to a second data format suitable for the destination of the content. Additionally, at reference numeral 914, a scope associated with the online service that hosts the online content can be converted to a second scope associated with one of a second online service or the backup data store.

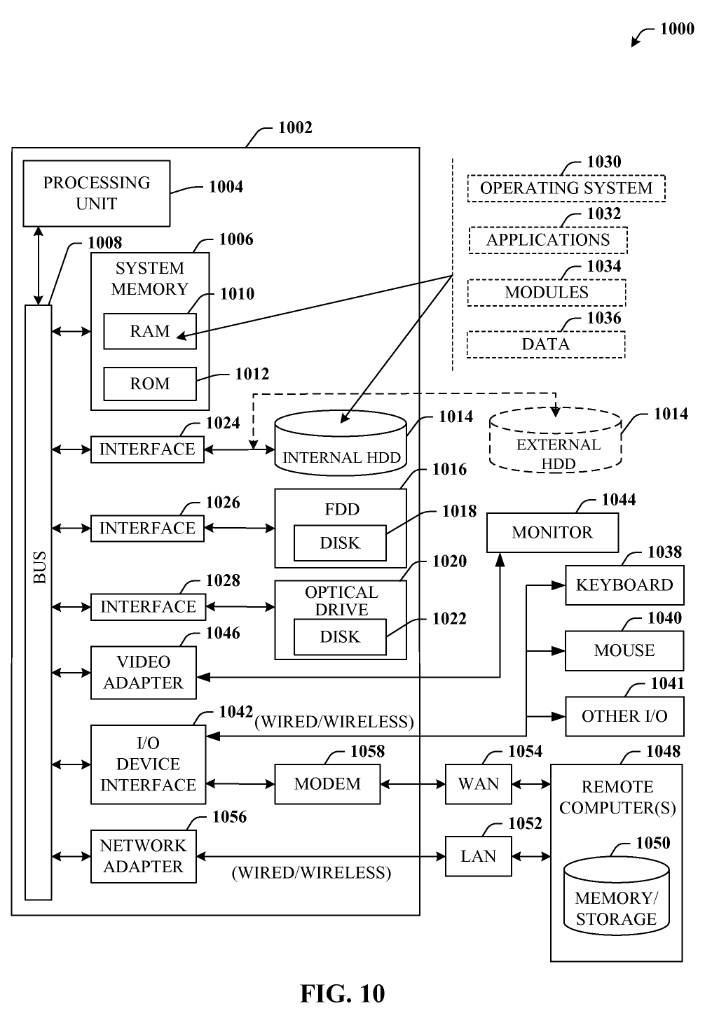

Referring now to FIG. 10, there is illustrated a block diagram of an exemplary computer system operable to execute the disclosed architecture. In order to provide additional context for various aspects of the claimed subject matter, FIG. 10 and the following discussion are intended to provide a brief, general description of a suitable computing environment 1000 in which the various aspects of the claimed subject matter can be implemented. Additionally, while the claimed subject matter described above may be suitable for application in the general context of computer-executable instructions that may run on one or more computers, those skilled in the art will recognize that the claimed subject matter also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the claimed subject matter may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media can include both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 10, the exemplary environment 1000 for implementing various aspects of the claimed subject matter includes a computer 1002, the computer 1002 including a processing unit 1004, a system memory 1006 and a system bus 1008. The system bus 1008 couples to system components including, but not limited to, the system memory 1006 to the processing unit 1004. The processing unit 1004 can be any of various commercially available processors. Dual microprocessors and other multi-processor architectures may also be employed as the processing unit 1004.

The system bus 1008 can be any of several types of bus structure that may further interconnect to a memory bus (with or without a memory controller), a peripheral bus, and a local bus using any of a variety of commercially available bus architectures. The system memory 1006 includes read-only memory (ROM) 1010 and random access memory (RAM) 1012. A basic input/output system (BIOS) is stored in a non-volatile memory 1010 such as ROM, EPROM, EEPROM, which BIOS contains the basic routines that help to transfer information between elements within the computer 1002, such as during start-up. The RAM 1012 can also include a high-speed RAM such as static RAM for caching data.

The computer 1002 further includes an internal hard disk drive (HDD) 1014 (e.g., EIDE, SATA), which internal hard disk drive 1014 may also be configured for external use in a suitable chassis (not shown), a magnetic floppy disk drive (FDD) 1016, (e.g., to read from or write to a removable diskette 1018) and an optical disk drive 1020, (e.g., reading a CD-ROM disk 1022 or, to read from or write to other high capacity optical media such as the DVD). The hard disk drive 1014, magnetic disk drive 1016 and optical disk drive 1020 can be connected to the system bus 1008 by a hard disk drive interface 1024, a magnetic disk drive interface 1026 and an optical drive interface 1028, respectively. The interface 1024 for external drive implementations includes at least one or both of Universal Serial Bus (USB) and IEEE1394 interface technologies. Other external drive connection technologies are within contemplation of the subject matter claimed herein.

The drives and their associated computer-readable media provide nonvolatile storage of data, data structures, computer-executable instructions, and so forth. For the computer 1002, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the claimed subject matter.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. It is appreciated that the claimed subject matter can be implemented with various commercially available operating systems or combinations of operating systems.

A user can enter commands and information into the computer 1002 through one or more wired/wireless input devices, e.g., a keyboard 1038 and a pointing device, such as a mouse 1040. Other input devices 1041 may include a speaker, a microphone, a camera or another imaging device, an IR remote control, a joystick, a game pad, a stylus pen, touch screen, or the like. These and other input devices are often connected to the processing unit 1004 through an input-output device interface 1042 that can be coupled to the system bus 1008, but can be connected by other interfaces, such as a parallel port, an IEEE1394 serial port, a game port, a USB port, an IR interface, etc.

A monitor 1044 or other type of display device is also connected to the system bus 1008 via an interface, such as a video adapter 1046. In addition to the monitor 1044, a computer typically includes other peripheral output devices (not shown), such as speakers, printers, etc.

The computer 1002 may operate in a networked environment using logical connections via wired and/or wireless communications to one or more remote computers, such as a remote computer(s) 1048. The remote computer(s) 1048 can be a workstation, a server computer, a router, a personal computer, a mobile device, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wired/wireless connectivity to a local area network (LAN) 1052 and/or larger networks, e.g., a wide area network (WAN) 1054. Such LAN and WAN networking environments are commonplace in offices and companies, and facilitate enterprise-wide computer networks, such as intranets, all of which may connect to a global communications network, e.g., the Internet.

When used in a LAN networking environment, the computer 1002 is connected to the local network 1052 through a wired and/or wireless communication network interface or adapter 1056. The adapter 1056 may facilitate wired or wireless communication to the LAN 1052, which may also include a wireless access point disposed thereon for communicating with the wireless adapter 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wired or wireless device, is connected to the system bus 1008 via the interface 1042. In a networked environment, program modules depicted relative to the computer 1002, or portions thereof, can be stored in the remote memory/storage device 1050. It will be appreciated that the network connections shown are exemplary and other means of establishing a communications link between the computers can be used.

The computer 1002 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE802.11(a, b, g, etc.) to provide secure, reliable, fast wireless connectivity. A Wi-Fi network can be used to connect computers to each other, to the Internet, and to wired networks (which use IEEE802.3 or Ethernet). Wi-Fi networks operate in the unlicensed 2.4 and 5 GHz radio bands, at an 10 Mbps (802.11b) or 54 Mbps (802.11a) data rate, for example, or with products that contain both bands (dual band), so the networks can provide real-world performance similar to the basic “10 BaseT” wired Ethernet networks used in many offices.

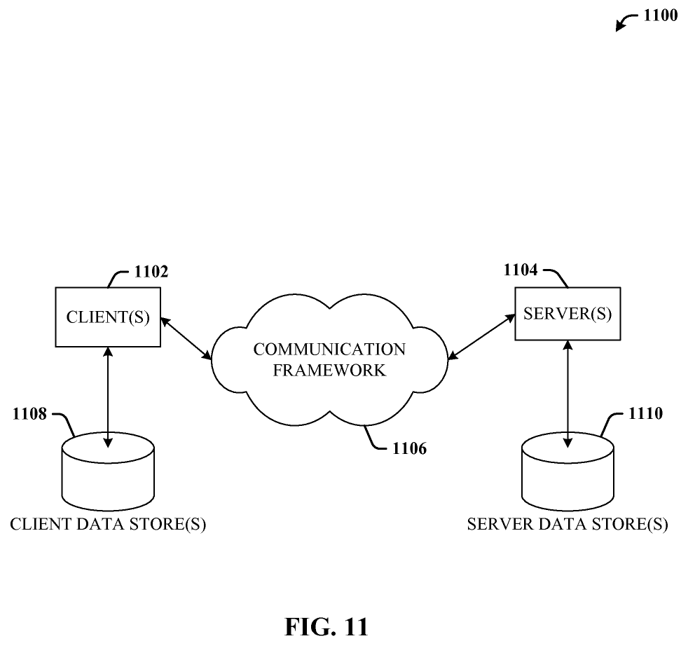

Referring now to FIG. 11, there is illustrated a schematic block diagram of an exemplary computer compilation system operable to execute the disclosed architecture. The system 1100 includes one or more client(s) 1102. The client(s) 1102 can be hardware and/or software (e.g., threads, processes, computing devices). The client(s) 1102 can house cookie(s) and/or associated contextual information by employing the claimed subject matter, for example.

The system 1100 also includes one or more server(s) 1104. The server(s) 1104 can also be hardware and/or software (e.g., threads, processes, computing devices). The servers 1104 can house threads to perform transformations by employing the claimed subject matter, for example. One possible communication between a client 1102 and a server 1104 can be in the form of a data packet adapted to be transmitted between two or more computer processes. The data packet may include a cookie and/or associated contextual information, for example. The system 1100 includes a communication framework 1106 (e.g., a global communication network such as the Internet) that can be employed to facilitate communications between the client(s) 1102 and the server(s) 1104.

Communications can be facilitated via a wired (including optical fiber) and/or wireless technology. The client(s) 1102 are operatively connected to one or more client data store(s) 1108 that can be employed to store information local to the client(s) 1102 (e.g., cookie(s) and/or associated contextual information). Similarly, the server(s) 1104 are operatively connected to one or more server data store(s) 1110 that can be employed to store information local to the servers 1104.

What has been described above includes examples of the various embodiments. It is, of course, not possible to describe every conceivable combination of components or methodologies for purposes of describing the embodiments, but one of ordinary skill in the art may recognize that many further combinations and permutations are possible. Accordingly, the detailed description is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the embodiments. In this regard, it will also be recognized that the embodiments includes a system as well as a computer-readable medium having computer-executable instructions for performing the acts and/or events of the various methods.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A computer implemented system that facilitates automatic versioned backup of online content, comprising:
a connection component that accesses a store associated with an online service on behalf of a user of the online service;
a propagation component that imports online content associated with the user and maintained by the online service from the store; and
a backup component that archives the online content to a central backup data store as a recent version of the online content.

2. The system of claim 1, the connection component employs credentials of the user when accessing the store based upon authorization from the user.

3. The system of claim 1, the online content is social networking-oriented data published by the user to the online service.

4. The system of claim 1, the online content is one or more contact lists, favorites lists, or objects associated with the user, or metadata associated with the online content, the objects, or a layout or schema associated with the online content.

5. The system of claim 1, the backup component compares online content maintained by the store to an existing version of archived content included in the central backup data store, and further identifies a portion of the online content that differs from the existing version.

6. The system of claim 5, the propagation component imports only the portion, and the backup component archives the portion as the recent version.

7. The system of claim 1, the central backup data store maintains multiple versions of the online content as archived content.

8. The system of claim 1, the central backup data store maintains aggregated archived content imported from multiple online services.

9. The system of claim 1, further comprising an interface component that provides a view of archived content included in the central backup data store.

10. The system of claim 9, the view presents at least one version of archived content imported from the online service or presents one or more versions of aggregated archived content imported from multiple online services.

11. The system of claim 1, further comprising a restore component that selects from the central backup data store archived content associated with the user, the archived content is designated for a restoration operation.

12. The system of claim 11, the propagation component exports the archived content to at least one of the online service, a disparate online service, or a user device associated with the user in accordance with the restoration operation.

13. The system of claim 1, further comprising a content converter component that converts at least one of (A) a data format associated with the online content or archived content to a disparate data format; or (B) a scope associated with the online service that hosts the online content to a disparate scope associated with a disparate online service or with the central backup data store.

14. The system of claim 13, the propagation component exports converted content to at least one of a disparate online service or a user device associated with the user.

15. The system of claim 1, further comprising a synchronization component that selects from the central backup data store archived content associated with the user or that selects online content from the store associated with the online service, the archived content or the online content is designated for a synchronization operation.

16. The system of claim 15, the propagation component exports the archived content or the online content to at least one of a disparate online service or a user device associated with the user.

17. A computer implemented method for facilitating automatic backup and versioning of online content, comprising:
interfacing with a remote store associated with an online service on behalf of a user of the online service;
obtaining online content associated with the user from the store managed by the online service;
employing a processor for automatically archiving the online content to a central backup data store; and
maintaining archived content in the backup data store as a recent version of online content.

18. The method of claim 17, further comprising at least one of the following acts:
obtaining from the store social networking-oriented online content published by the user;
obtaining from the store online content comprising one or more contact list or objects associated with the user, or metadata associated with the online content, the objects, or a layout or schema associated with the online content;
obtaining authorization from the user for utilizing a credential associated with the user for interfacing with the remote store;
comparing online content maintained by the online service to an existing version of archived content included in the backup data store;
identifying a portion of online content that varies from the existing version; or
obtaining and archiving only the portion.

19. The method of claim 17, further comprising at least one of the following acts:
presenting a view of archived content included in the backup data store;
restoring archived content from the backup data store to the store associated with the online service;
restoring archived content from the backup data store to a store associated with a disparate online service or a device associated with the user;
synchronizing online content managed by the online service with online content managed by a disparate online service;
synchronizing archived content included in the backup data store with online content managed by a disparate online service;
converting a data format associated with the online content or archived content to a second data format; or
converting a scope associated with the online service that hosts the online content to a second scope associated with one of a second online service or the backup data store.

20. A computer implemented system that facilitates backup or restore of online content, comprising:
a connection component that accesses a store associated with an online service on behalf of a user of the online service;
a propagation component that imports online content associated with the user and maintained by the online service from the store;
a backup component that archives the online content to a central backup data store as a recent version of the online content; and
a restore/synch component that is configured to restore or synchronize archived content included in the backup data store to at least one of the store associated with the online service or to a disparate store associated with a disparate online service.
